(19) United States
(12) Patent Application Publication
(10) Pub. No.: US 2008/0098998 A1
(43) Pub. Date: May 1, 2008

(54) Engine mounted air-to-air aftercooler

(76) Inventor: Paul A. Dicke, Peoria, IL (US)

Correspondence Address: Caterpillar Inc.;Intellectual Property Dept., AB 6490, 100 N.E. Adams Street, PEORIA, IL, 61629-6490, US

(21) Appl. No.: 11/589,373

(22) Filed: Oct. 30, 2006

(51) Int. Cl. F02B 33/00; F02B 29/04

(52) U.S. Cl. 123/563; 123/565; 60/599

(57) ABSTRACT

A combustion air cooling system has an aftercooler operable to supply cooled air to the intake manifold of an engine. A fan is operable to force ambient air through the aftercooler. A variable speed fan drive is operable to control the speed of the fan.

### TECHNICAL FIELD

The present disclosure relates generally to an air-to-air aftercooler, and more particularly, to an air-to-air aftercooler to cool charge gas exiting a turbocharger or a supercharger.

### BACKGROUND

As is known in the internal combustion engine (ICE) art, and the motor vehicle industry employing such engines for use in the vehicle drive train, federal governmental regulations, as issued within the past years, for example, by the Environmental Protection Agency (EPA), have mandated that NOx emissions be reduced. One scheme or mode of operating internal combustion engines by means of which such NOx emissions have in fact been able to be reduced has been to incorporate exhaust gas recirculation (EGR) techniques into the engine inlet air supply system. Another scheme or mode of operating internal combustion engines by means of which such NOx emissions have also in fact been able to be reduced has been to provide increased cooling of the incoming turbocharged air being conducted into the engine inlet manifold.

One way to achieve such increased cooling of the incoming turbocharged air being conducted into the engine inlet manifold is to of course increase the size or density of the main engine heat exchanger or radiator-type cooling system whereby, in effect, more cooling surface area is provided within the heat exchanger or radiator. Conventionally, an internal combustion engine vehicle has a single or main heat exchanger or radiator-type cooling system for performing or satisfying all heat load requirements of the engine, such as, for example, those attendant the water jacket, the hydraulic systems, the power train, and the like. However, such an increase in the size or density of the main engine heat exchanger or radiator is not always possible considering size constraints or limitations for housing the main heat exchanger or radiator upon or within a particular vehicle. In addition, such an increase in the size or density of the main engine heat exchanger or radiator entails a substantial increase in the resulting pressure drop across or characteristic of such heat exchanger or radiator which, in turn, necessitates increased power input levels or requirements in order to achieve sufficient air flow through the system. Such increased power input requirements or levels can be attained or met, for example, by increasing the speed of the main engine cooling fan, however, increasing the speed of the main engine cooling fan results in unacceptable noise levels.

As stated above, machines having a power source, such as an internal combustion engine, may also include a turbocharger or a supercharger directed to increase the mass flow of air delivered to the engine to increase its power density. The charge air exiting the turbocharger or the supercharger may be cooled using a heat exchanger, or an aftercooler, before being input into the engine cylinders. For example, a turbocharger or supercharger outlet may be fluidly connected to an air intake manifold of a machine power source through an air-to-air heat exchanger. This heat exchanger may be mounted on or close to the machine power source to conserve space on the machine and to decrease the pressure drop of the turbocharged air. A fan may be used to provide cooling air for the turbocharged air in the heat exchanger. However, because the heat exchanger is mounted on the or close to the machine power source, it may be difficult to provide a sufficient quantity of cooling air for the heat exchanger.

One method of providing cooling air to an air-to-air heat exchanger employed to cool turbocharged air is described in U.S. Pat. No. 6,318,347 issued to Dicke et al. The '347 patent describes an air-to-air heat exchanger (or, aftercooler) mounted near an internal combustion engine, designed to cool charged air before the air enters the engine cylinders. The air-to-air heat exchanger is provided with cooling air by a dedicated fan powered by the engine, to provide cooling air for the heat exchanger.

Although the system of the '347 patent may increase the quantity of cooling air flowing though the heat exchanger, it may not be able to vary the quantity of cooling air flowing through the heat exchanger in response to changing operating conditions of the engine. In particular, even though the dedicated aftercooler fan of the '347 patent provides cooling air for the aftercooler independent of the main radiator cooling fan, the aftercooler fan nevertheless provides a constant flow of cooling air across the aftercooler. The system of the '347 patent does not provide active control of the quantity of cooling air provided to the aftercooler to enable changing the level of cooling of the turbocharged air.

The present disclosure is directed to overcoming one or more of the problems or disadvantages existing in the prior art.

### SUMMARY OF THE DISCLOSURE

In one aspect, the present disclosure is directed to a combustion air cooling system mounted on an engine in a machine. The engine has an intake manifold. The combustion air cooling system includes an aftercooler operable to supply cooled air to the intake manifold. A fan is operable to force ambient air through the aftercooler. A variable speed fan drive is operable to control the speed of the fan.

In another aspect, the present disclosure is directed to a combustion air induction system and engine assembly. The engine has an intake manifold and an exhaust manifold. The combustion air induction system includes a turbocharger operable to produce a supply of compressed air using a supply of exhaust from the exhaust manifold. An aftercooler is mounted on the engine. The aftercooler is operable to cool the supply of compressed air from the turbocharger. A fan is operable to force ambient air through the aftercooler. A variable speed fan drive is operable to control the speed of the fan.

In another aspect, the present disclosure is directed to a method of cooling combustion air for use with an engine. The engine has an intake manifold. The method of cooling includes providing an engine cooling system. The engine cooling system has a heat exchanger being an air-to-air type heat exchanger. A variable flow of ambient air is provided as a recipient fluid to the heat exchanger. A flow of combustion air is provided as a source fluid to the heat exchanger. The engine is supplied with a flow of cooled combustion air from the heat exchanger. A condition within at least one of the engine and engine cooling system is then monitored. The supply of flow of ambient air to the heat exchanger is adjusted in response to the monitored condition.

### BRIEF DESCRIPTION OF THE DRAWINGS

FIG. 1 is a schematic illustration of a first embodiment of a combustion air induction system having an air-to-air aftercooler incorporated in an engine system.

FIG. 2 is a perspective view of the combustion air induction system and engine system depicted in FIG. 1.

FIG. 3 is a perspective view of a second embodiment of a combustion air induction system having an air-to-air aftercooler incorporated in an engine system.

FIG. 4 is a flow diagram of a control algorithm for controlling the operation of the air-to-air aftercooler depicted in FIG. 1.

### DETAILED DESCRIPTION

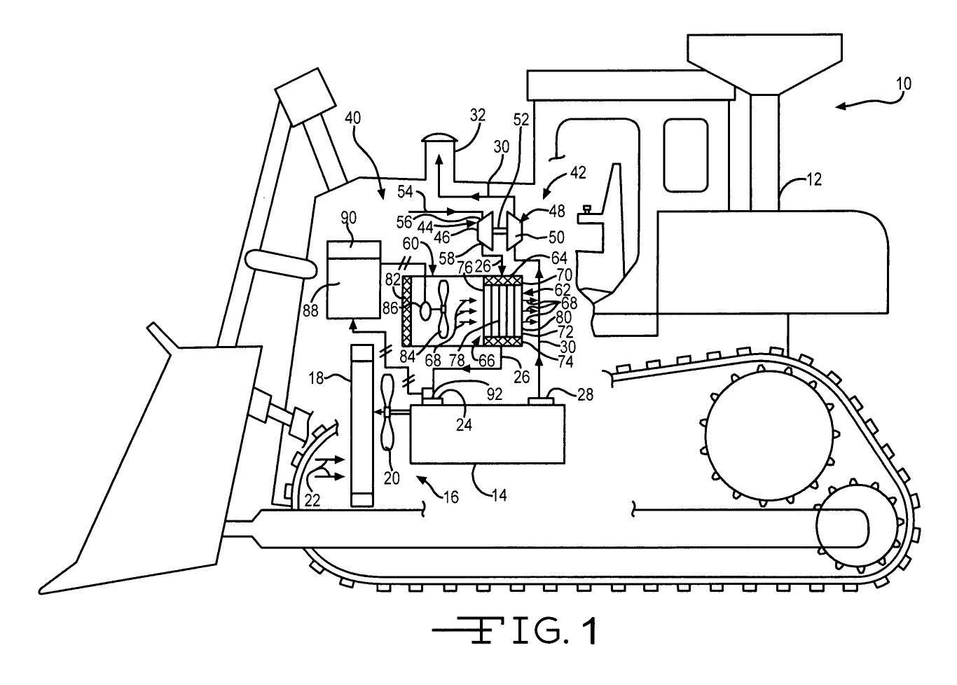

FIG. 1 illustrates an exemplary machine 10 having multiple systems and components that cooperate to accomplish a task. The machine 10 may embody a fixed or mobile machine that performs some type of operation associated with an industry such as mining, construction, farming, transportation, or any other industry known in the art. For example, the machine 10 may be an earth-moving machine such as an excavator, a dozer, a loader, a backhoe, a motor grader, a dump truck, or any other earth moving machine. The machine 10 includes a chassis 12 and an engine 14 mounted within the chassis 12. An engine cooling system 16 is positioned in the chassis 12 and communicates a liquid coolant (not shown), between a heat exchanger or radiator 18 and the engine 14. The heat exchanger 18 is a conventional liquid-to-air type heat exchanger, although any heat exchanger can be used with the embodiment described. A fan 20 is positioned in the engine cooling system 16 and operatively causes a flow of a recipient fluid, represented by the arrows 22, such as atmospheric air, to pass through the heat exchanger 18. In this application, the coolant (not shown) acts as a source fluid and the atmospheric air 22 acts as the recipient fluid. The fan 20 in this application is driven by an electric motor (not shown) but as an alternative could be driven by another source such as a hydraulic motor or could be driven directly from the engine 14.

The engine 14 may be any conventional engine. The engine 14 has an inlet manifold 24 that allows a flow of compressed or pressurized combustion air, indicated by the arrow and the line 26, into the engine 14 as will be described below. The engine 14 has an exhaust manifold 28 allowing a flow of exhaust gas, indicated by the arrow and line 30, from the engine 14 to enter an exhaust stack 32, as will also be described below.

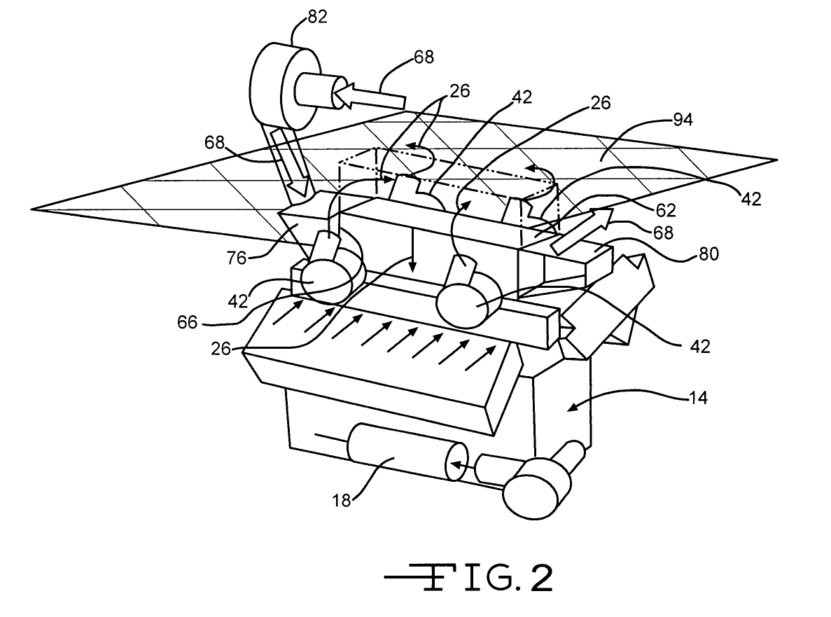

Referring now to FIGS. 1 and 2, the engine 14 includes a first embodiment of a combustion air induction system, indicated generally at 40. The combustion air induction system 40 includes a turbocharger 42. The turbocharger 42 has a compressor section 44 including a compressor wheel 46 therein. The turbocharger 42 has a turbine section 48 having a turbine wheel 50 being connected to a shaft 52. The shaft 52 is connected to the compressor wheel 46 in a conventional manner. The flow of exhaust gas 30 is communicated from the exhaust manifold 28 to the turbine section 48 in a generally conventional manner. Atmospheric air, represented by arrows 54, enters an inlet portion 56 of the compressor section 44 and is compressed forming a first flow of combustion air at a pre-established pressure ratio for use as the compressed combustion air 26. It will be appreciated that the atmospheric air 54 may be filtered prior to entering the turbocharger 42, such as by a filter or an air cleaner (not shown) as would be known by one skilled in the art. The compressed combustion air 26 exits an outlet portion 58 of the compressor section 44. The flow of compressed combustion air 26 is communicated between the compressor section 44 and the inlet manifold 24 in a generally known manner. The flow of exhaust gas 30 exits the turbocharger 42 to atmosphere through the stack 32.

The combustion air induction system 40 includes a charge air cooling (CAC) or combustion air cooling system 60. The combustion air cooling system 60 has an intercooler or aftercooler 62 positioned therein that may be mounted on the engine 14. In this embodiment, the aftercooler 62 is mounted on the engine 14 between the inlet manifold 24 and the exhaust manifold 28 and is of an air-to-air type heat exchanger configuration, as is most clearly shown in FIG. 2. Additionally, connections (not shown) from the inlet manifold 24 and the exhaust manifold 28, respectively, to the aftercooler 62 would be incorporated into the design of the aftercooler 62 and/or the engine 14. The aftercooler 62 has a source portion 64 in communication with the compressed combustion air 26 and a recipient portion 66 in communication with the atmospheric air, represented by the arrows and lines 68. The source portion 64 has a combustion air inlet portion 70, a combustion air transfer portion 72 and a combustion air outlet portion 74. The recipient portion 66 has an atmospheric air inlet portion 76, an atmospheric air transfer portion 78 and an atmospheric air outlet portion 80. The combustion air inlet portion 70 is connected to the outlet portion 58 of the compressor section 44 in any conventional manner.

The combustion air cooling system 60 may further include a filtration system 82, although such a device is not required. The filtration system 82 may be used to extract debris or particulate matter from the atmospheric air 68 prior to the atmospheric air 68 entering the aftercooler 62. It will be appreciated that the filtration system 82 may include a connection for extracting debris from the filtered atmospheric air 68 and may utilize the Venturi effect of the exhaust system of the machine 10 to extract such debris. It will further be appreciated that although the filtration system 82 is not required in any of the illustrated or described embodiments, the addition of the filtration system 82 may be desirable because the filtration system 82 may allow for a higher fin density on the recipient portion 66 of the aftercooler 62, which will reduce the size of the aftercooler 62. As shown, the filtration system 82 is mounted to the engine 14.

The combustion air cooling system 60 may further include a fan 84 that is operable to increase the flow of the atmospheric air 68 into the source portion 64 of the aftercooler 62 and through the aftercooler 62. A drive mechanism 86 is provided to power the fan 84. The drive mechanism 86 may be a belt drive, hydraulic pump and drive motor, electric motor, or any other drive mechanism. In the illustrated embodiment, to achieve the desired pressure rise capabilities, the fan 84 is a radial or centrifugal type fan. However, it will be appreciated that the fan 84 may also be an axial or mixed flow fan. It will further be appreciated that the fan 84 may be mounted upstream or downstream of the filtration system 82.

In another embodiment, the combustion air cooling system 60 may further include a variable speed fan drive 88 to control the operation of the fan 84. The variable speed fan drive 88 may include an electronic control module 90 having a control algorithm for controlling the speed of the fan 84. The input to the control algorithm of the variable speed fan drive 88 could include the input from various sensors for detecting conditions within and/or surrounding the machine 10. For example, in the exemplary embodiment, an inlet manifold temperature (IMT) sensor 92 is provided to detect the inlet manifold air temperature. The control algorithm of the variable speed fan drive 88 calculates the speed of the fan 84 required so that the air temperature in the inlet manifold 24 remains below a pre-determined threshold temperature value. The variable speed fan drive 88 may also incorporate other operating parameters, such as exhaust temperature, throttle position, engine speed, or load conditions, into the control algorithm for controlling the speed of the fan 84. It will further be appreciated that sensors (not shown) to detect these other operating parameters may be provided and connected to the variable speed fan drive 88 in any conventional manner. In another example, the variable speed fan drive 88 is a variable displacement hydraulic drive. The electronic control module 90 determines the speed of the fan 84 to meet a desired air temperature in the inlet manifold based on the engine speed and engine load conditions or torque demand. The speed of the fan 84 may be controlled so that the machine 10 meets emissions requirements, while optimizing fuel cost and/or power. It will also be appreciated that the electronic control module (not shown) of the engine 14 may be programmed to control the speed of the fan 84 as described herein or in any other suitable manner.

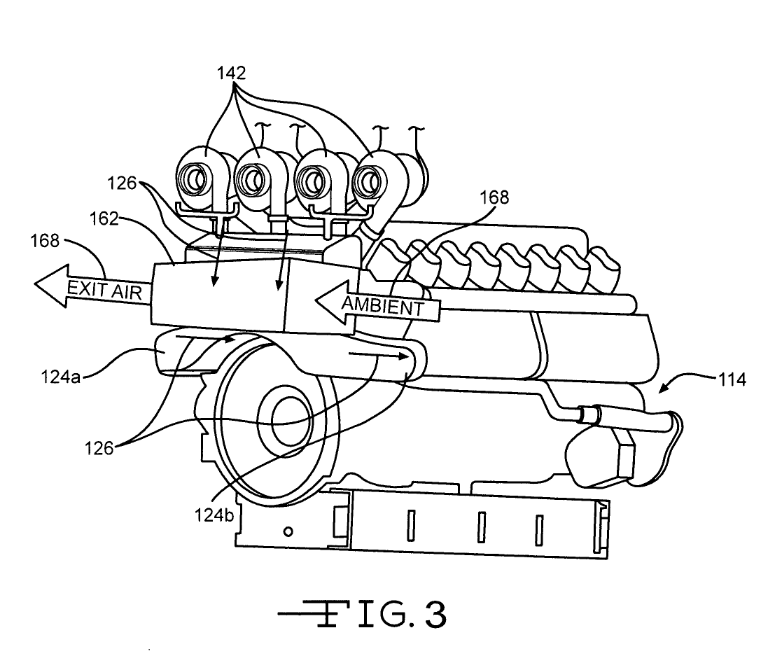

The combustion air cooling system 60 may be mounted on the top or side of the engine 14, as shown in FIG. 2. The combustion air cooling system 60 may also be mounted on the engine 14, such that the aftercooler 62 may be mounted on the engine 14 between the inlet manifold 24 and the exhaust manifold 28 and is of an air-to-air type heat exchanger configuration. Mounting the combustion air cooling system 60 against the engine 14 may be desirable to reduce the space required for the engine 14 and air cooling system 60 assembly. As shown in FIG. 3, mounting the combustion air cooling system 60 on the engine 14 may be desirable to accommodate a low hood line 94 of the machine 10, although this is not required. It will be appreciated that for an in-line engine, the combustion air cooling system 60 may be mounted on top of the head of the engine. It will further be appreciated that for an engine having a cross flow head design, the combustion air cooling system 60 may be mounted on the inlet manifold side of the engine.

A second embodiment of a combustion air induction system, indicated generally at 140, is shown in FIG. 3. The combustion air induction system 140 is generally similar to the combustion air induction system 40 and only the differences will be explained herein. The combustion air induction system 140 is mounted on a vee engine 114. As shown, the aftercooler 162 is mounted transverse to the engine 114. The engine 114 includes a first outboard intake manifold 24a and a second outboard intake manifold 24b. The cooled compressed combustion air 126 is split into both the first and second outboard intake manifolds 24a and 24b.

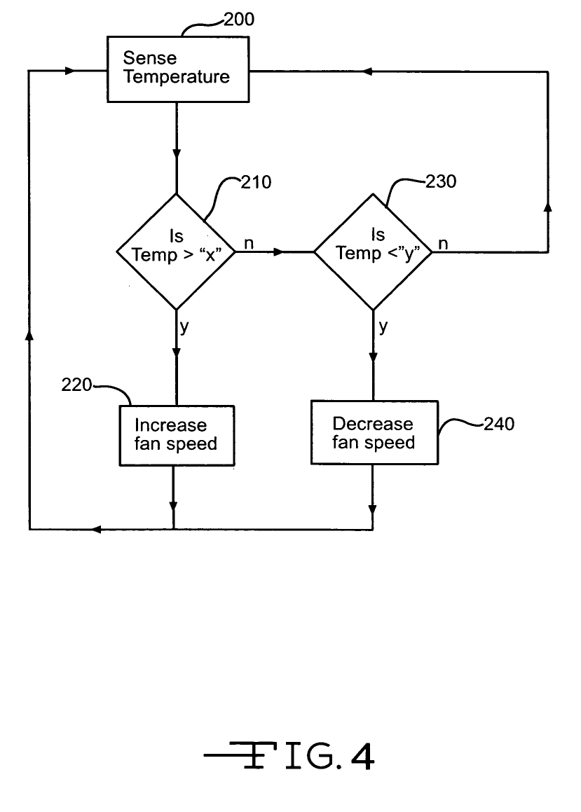

Referring now to FIG. 4, a method of controlling the speed of a fan in a combustion air cooling system, such as the fan 84 in the combustion air cooling system 60, is illustrated in accordance with the illustrated embodiment. It will be appreciated that the method may be implemented by a variable speed fan drive, such as the variable speed fan drive 88. The method begins at step 200 in which a temperature is detected or sensed from a sensor within the machine 10. For the purpose of illustration, the sensed temperature will be described as the air temperature at the inlet manifold as determined by an inlet manifold temperature sensor, such as that shown at 92 in FIG. 1, although it will be appreciated that the temperature parameter that is sensed may be detected using any temperature sensor within any portion of the machine 10.

The method then advances to step 210 in which the sensed temperature is compared to an upper threshold value x. If the sensed temperature is determined to be greater than the upper threshold value x, the method advances to step 220. At step 220, a command is sent to the fan drive to increase the fan speed. The method then loops back to step 200 and the method begins again.

Returning now to step 210, if the sensed temperature is determined to be not greater than the upper threshold value x, the method advances to step 230. At step 230, the sensed temperature is compared to a lower threshold value y. If the sensed temperature is determined to be less than the lower threshold value y, the method advances to step 240. At step 240, a command is sent to the fan drive to decrease the fan speed. The method then loops back to step 200 and the method begins again.

Returning now to step 230, if the sensed temperature is determined to be not less than the lower threshold value y, the method loops back to step 200 and the method begins again. Thus, if the sensed temperature is not greater than the upper threshold x and is not lower than the lower threshold temperature y, then the fan speed is not changed.

It will be appreciated that the upper temperature threshold x and the lower temperature threshold y may each be dependent upon various operating parameters of the machine 10, such as exhaust temperature or throttle position. It will further be appreciated that the upper temperature threshold x and the lower temperature threshold y may be dynamic in response to such various operating parameters.

### INDUSTRIAL APPLICABILITY

The maximum power of an engine is limited primarily by its combustion air supply because the output power of an engine depends on the amount of fuel that can be burned inside the cylinders. To increase power, the engine typically must be able to burn more fuel, which can means the engine requires a greater volumetric efficiency. Volumetric efficiency in internal combustion engine design refers to the efficiency with which the engine can move the charge into and out of the cylinders. One way to increase power is to supply the engine with additional air. Turbochargers and superchargers are designed to increase the amount of air delivered to the engine by delivering compressed air, called charge air, to the engine. The turbocharger or supercharger increases the pressure of the air entering the engine, so a greater mass of oxygen enters the combustion chamber in the same time interval. This may improve the power output of the engine. In general, the engine crankshaft mechanically drives a supercharger; whereas turbochargers are driven by waste exhaust gases from the engine exhaust system. For the sake of brevity, this disclosure will refer to both a turbocharger and a supercharger as a turbocharger.

The temperature of the charge air increases considerably due to turbocharging. Since hot air is less dense than cooler air at the same pressure, the quantity of charge air delivered to the engine is decreased due to the increase in temperature. By cooling the charge air after compression, the quantity of air delivered to the engine can be increased, thereby increasing the power output of the engine. An aftercooler (sometimes called an intercooler) is used to cool the charge air entering the engine. Cooling achieved by using either air or a liquid coolant, like the cooling fluid) as the cooling medium. In both cases, heat transfer from the hot charge air to the relatively cooler cooling medium is accomplished through convection heat transfer.

Some of the performance metrics that drive the choice of an aftercooler are its physical size, temperature of the charge air entering the engine cylinder intake manifold—the intake manifold temperature (IMT), the mass flow of air entering the intake manifold, the pressure drop of the charge air from the turbocharger outlet to the cylinder intake manifold, and the desired acceleration response. The size of the aftercooler should be small enough to fit into the engine compartment without having the need to enlarge the compartment. Low intake manifold temperatures are required both to increase the quantity of air entering the cylinder and to maintain low exhaust emissions. NOx emissions are very sensitive to the air-fuel ratio of the combustion mixture in the cylinder and to the IMT. To maintain low NOx emissions while increasing the power output of the engine, low IMT's are required. The pressure drop of the charge air exiting the turbocharger before it enters the cylinder intake manifold should also be minimal so as to minimize the decrease in quantity of air supplied to the cylinder (which can also reduce the efficiency of the compressor). Also, since the engine should be capable of accepting the full design load in a few seconds after being started, the turbocharger and the aftercooler should be located close to the cylinder intake manifold so that the time taken to provide enough quantity of high pressure, low temperature charge air to the cylinder for good combustion is minimized. Therefore, the aftercooler should be able to cool the charge air exiting the turbocharger to a low IMT with a minimal drop in pressure, while maintaining a small size.

In an air-to-air (ATA) aftercooler system, the charge air at the turbocharger discharge is ducted to a heat exchanger assembly (the aftercooler), cooled, and then continues on to the engine inlet. The aftercooler is typically placed where the outside cooling air passes through it. In a typical ATA aftercooler system, the aftercooler placed in front of the engine radiator to use cool ambient air as the cooling source. This location of the aftercooler increases the length of the piping or the ductwork that the charge air has to travel to reach the cylinder intake manifold from the turbocharger exit. This increased travel distance increases the pressure drop of the charge air and adversely affects the acceleration response of the engine. In an air-to-liquid (ATL) aftercooler system, the charge air at the turbocharger discharge is ducted to a heat exchanger assembly (aftercooler), cooled, and then continues to the engine inlet, much like the ATA system. However, the ATL assembly does not need direct exposure to outside cooling air, since the cooling liquid can be easily ducted to the aftercooler. Because of this, the aftercooler can be placed close to the cylinder intake manifold, in the existing path between the turbocharger discharge and the intake manifold. This decreased distance that the charge air has to travel between the turbocharger outlet and the cylinder intake manifold decreases the charge air pressure drop and enhances the acceleration response of the engine.

The physical properties of the cooling media form the basis of heat removal in convection cooling. Air has a low density and a reduced ability to carry heat per unit mass (specific heat), as compared to a liquid which is denser and has a higher specific heat. The combination of a cooling medium's density and its specific heat equal its ability to carry and remove heat. Due to the lower ability of air to remove heat, a larger volume of air will have to be blown through the aftercooler to cool charge air by a same amount as compared to an ATL aftercooler. The surface area required for heat transfer between the charge air and the cooling air determines the size of the aftercooler. The heat transfer coefficient (heat transfer per unit area) for typical cooling liquids are orders of magnitude higher than that of air, so the surface area required for an ATA aftercooler is significantly higher than that of an ATL aftercooler. Although ATL aftercoolers are more efficient from a heat transfer perspective, ATA aftercoolers are most cost effective for some engine applications, since ATL aftercoolers are more expensive to install and maintain, given the need for leak proof plumbing and a secondary heat exchanger to cool the cooling medium.

Currently, engines meeting U.S. EPA Tier 2 emission levels typically require 45-50° C. IMT. In the near future, engines above 750 hp will also be required to meet U.S. EPA Tier 2 emission requirements. To meet projected engine performance and emissions targets, an increasing mass flow rate of charge air with pressure drop (from the turbocharger outlet to the engine intake manifold) not exceeding 16 Kpa must be supplied to the engine. This will require very large ATA aftercoolers with 5-7″ diameter pipes, with physical sizes exceeding current equipment main frame rail widths and hood heights.

As such, according to the embodiments described herein, the combustion air cooling system includes a variable speed fan drive 88 to control the operation of the fan 84. The variable speed fan drive 88 includes an electronic control module 90 having a control algorithm for controlling the speed of the fan 84. The input to the control algorithm of the variable speed fan drive 88 includes the input from various sensors for detecting conditions within and/or surrounding the machine 10. For example, as stated above, an inlet manifold temperature (IMT) sensor 92 is provided to detect the inlet manifold air temperature. The control algorithm of the variable speed fan drive 88 calculates the speed of the fan 84 required so that the air temperature in the inlet manifold 26 remains below a pre-determined threshold temperature value. The variable speed fan drive 88 may also incorporate other operating parameters, such as exhaust temperature, throttle position, engine speed, or load conditions, into the control algorithm for controlling the speed of the fan 84. It will further be appreciated that sensors (not shown) to detect these other operating parameters may be provided and connected to the variable speed fan drive 88 in any conventional manner. In another example, the variable speed fan drive 88 is a variable displacement hydraulic drive. The electronic control module 90 determines the speed of the fan 84 to meet a desired air temperature in the inlet manifold based on the engine speed and engine load conditions or torque demand. The speed of the fan 84 may be controlled so that the machine 10 meets emissions requirements, while optimizing fuel cost and/or power. It will also be appreciated that the electronic control module (not shown) of the engine 14 may be programmed to control the speed of the fan 84 as described herein or in any other suitable manner.

Therefore, according to the embodiments shown and described herein, the engine mounted air-to-air aftercooler is mounted on the engine and acts to increase the quantity of cooling air flowing though the heat exchanger. Additionally, an ECM can operate a fan to vary the quantity of cooling air flowing through the heat exchanger in response to changing operating conditions of the engine. Thus, the systems of the present disclosure provide active control of the quantity of cooling air provided to the aftercooler to enable changing the level of cooling of the turbocharged air.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A combustion air cooling system mounted on an engine in a machine, the engine having an intake manifold, the combustion air cooling system comprising:
an aftercooler operable to supply cooled air to the intake manifold;
a fan operable to force ambient air through the aftercooler; and
a variable speed fan drive operable to control the speed of the fan.

2. The system of claim 1, wherein the variable speed fan drive further includes an electronic control module having a control algorithm for controlling the speed of the fan.

3. The system of claim 2, wherein the control algorithm accepts inputs from various sensors that detect conditions within the machine.

4. The system of claim 2, further comprising an inlet manifold temperature sensor operable to detect the inlet manifold air temperature, wherein the control algorithm of the variable speed fan drive calculates the speed of the fan required based on the inlet manifold air temperature.

5. The system of claim 4, wherein the control algorithm of the variable speed fan drive calculates the speed of the fan required so that the air temperature in the inlet manifold remains below a pre-determined threshold temperature value.

6. The system of claim 2, wherein the control algorithm accepts inputs from sensors detecting at least one of exhaust temperature, throttle position, engine speed, or engine load conditions.

7. The system of claim 1, wherein the aftercooler is mounted on the engine between the intake manifold and an exhaust manifold.

8. The system of claim 1, further comprising a filtration system operable to filter ambient air prior to entry of the air into the aftercooler.

9. The system of claim 1, wherein the engine is an engine having an output of above 750 hp.

10. A combustion air induction system and engine assembly, the engine having an intake manifold and an exhaust manifold, the combustion air induction system comprising:
a turbocharger operable to produce a supply of compressed air using a supply of exhaust from the exhaust manifold;
an aftercooler mounted on the engine, the aftercooler operable to cool the supply of compressed air from the turbocharger;
a fan operable to force ambient air through the aftercooler; and
a variable speed fan drive operable to control the speed of the fan.

11. A method of cooling combustion air for use with an engine, the engine having an intake manifold; the method of cooling comprising:
(a) providing an engine cooling system, the engine cooling system having a heat exchanger being an air-to-air type heat exchanger;
(b) providing a variable flow of ambient air as a recipient fluid to the heat exchanger;
(c) providing a flow of combustion air as a source fluid to the heat exchanger;
(d) supplying the engine with a flow of cooled combustion air from the heat exchanger;
(e) monitoring a condition within at least one of the engine and engine cooling system; and
(f) adjusting the supply of flow of ambient air to the heat exchanger in response to the monitored condition.

12. The method of claim 11, wherein step (e) is performed by monitoring the temperature of the flow of cooled combustion air supplied to the engine at the intake manifold.

13. The method of claim 12, wherein step (f) is performed such that the temperature of the flow of cooled combustion air supplied to the engine is maintained within a pre-determined temperature threshold.

14. The method of claim 11, wherein step (f) is performed by controlling the speed of a fan operable to increase the flow of ambient air to the heat exchanger.
